(19) United States
(12) Patent Application Publication
(10) Pub. No.: US 2025/0024565 A1
(43) Pub. Date: Jan. 16, 2025

(54) HONEYCOMB STRUCTURE AND METHOD OF PRODUCING HONEYCOMB STRUCTURE

(71) Applicant: NGK INSULATORS, LTD., Nagoya-City (JP)

(72) Inventors: Hisashi NISHIKAWA, Nagoya-Shi (JP); Toru HAYASE, Nagoya-Shi (JP); Hirofumi YAMAGUCHI, Komaki-Shi (JP)

(73) Assignee: NGK INSULATORS, LTD., Nagoya-City (JP)

(21) Appl. No.: 18/735,632

(22) Filed: Jun. 6, 2024

(30) Foreign Application Priority Data
Jul. 11, 2023 (JP) 2023-113758

(51) Int. Cl. H05B 6/36; H01F 1/08

(52) U.S. Cl. CPC H05B 6/365; H01F 1/086; H05B 2206/022

(57) ABSTRACT

A honeycomb structure includes a base material that is a tubular member and provided with a plurality of cells extending from one end face to the other end face, and a coating layer provided on a surface of a target cell that is at least one of the plurality of cells, the coating layer being formed by magnetic particles bonded to one another. The coating layer contains at least one element selected from among Si, Al, and Mg as an additional element(s). In the coating layer, the ratio of the sum of the weight fraction(s) of the additional element(s) to the sum of the weight fraction(s) of a main constituent element(s) of the magnetic particles is higher than or equal to 1.7 wt %.

### CROSS-REFERENCE TO RELATED APPLICATIONS

This application claims priority benefit of Japanese Patent Application No. JP2023-113758 filed in the Japan Patent Office on Jul. 11, 2023, the entire disclosure of which is incorporated herein by reference.

### TECHNICAL FIELD

The present invention relates to a honeycomb structure and a method of producing a honeycomb structure.

### BACKGROUND ART

Technology called induction heating is conventionally known in which workpieces are heated by electromagnetic induction. Induction heating is achieved by placing an induction heating coil in the vicinity of a workpiece that contains a magnetic or conductive material and generating a magnetic field by the induction heating coil. For example, in the case of heating a columnar workpiece, an induction heating coil is provided around the outer periphery of the workpiece. Current that is passed through the induction heating coil during generation of a magnetic field may be obtained by, for example, amplifying an alternating current from a high-frequency inverter by a transformer. Induction heating that allows non-contact heating of a workpiece is particularly useful when heating a material with low thermal conductivity or when heating a workpiece under conditions in which thermal contact is not easy. Besides, as compared to indirect heating achieved by heat conduction, induction heating is direct heating achieved by self-heating and therefore exhibits high energy efficiency.

Technology for heating a catalyst carrier by induction heating is also known. For example, in the catalyst carrier disclosed in Japanese Patent Application Laid-Open No. 2019-188272, metal particles are introduced into internal spaces of selected cells among a plurality of cells of a ceramic base material. The metal particles adhere to the ceramic base material while being bonded to one another with a fixing agent. The metal particles generate heat in response to changes in magnetic field.

Meanwhile, in the case of forming a coating layer that contains magnetic particles on the surfaces (inner surfaces) of cells of a base material, the coating layer may have an uneven thickness. For example, in the case where the cells have an approximately square sectional shape, the coating layer will have a greater thickness at the corners of the cells than that on the other portions of the cells due to factors such as the influence of surface tension of slurry containing magnetic particles at the application of the slurry. Besides, large voids will be formed between the coating layer and the surfaces at the corners due to the influence of firing shrinkage. In this case, the evaluation of thermal shock resistance shows that stress concentration occurs at the boundaries between the non-contact portions (aforementioned voids) and the contact portions of the coating layer and the cell surfaces, and accordingly cracks appear in the base material. In this way, the honeycomb structure provided with the coating layer has low thermal shock resistance.

### SUMMARY OF THE INVENTION

It is an object of the present invention to provide a honeycomb structure having high thermal shock resistance.

A first aspect of the present invention is a honeycomb structure that includes a base material that is a tubular member and provided with a plurality of cells extending from one end face to the other end face, and a coating layer that is provided on a surface of a target cell that is at least one of the plurality of cells, the coating layer being formed by magnetic particles bonded to one another. The coating layer contains at least one element selected from among Si, Al, and Mg as an additional element(s). In the coating layer, a ratio of a sum of a weight fraction(s) of the additional element(s) to a sum of a weight fraction(s) of a main constituent element(s) of the magnetic particles is higher than or equal to 1.7 wt %.

According to the present invention, it is possible to provide a honeycomb structure having high thermal shock resistance.

A second aspect of the present invention is the honeycomb structure according to the first aspect, in which the main constituent element(s) of the magnetic particles includes Fe and Cr.

A third aspect of the present invention is the honeycomb structure according to the first or second aspect, in which the coating layer includes a compound that contains the additional element(s) and that exists at surfaces of the magnetic particles.

A fourth aspect of the present invention is the honeycomb structure according to any one of the first to third aspects, in which the coating layer has a relative density of 75% to 95%.

A fifth aspect of the present invention is the honeycomb structure according to any one of the first to fourth aspects, in which the coating layer has a thickness of 20 μm to 100 μm.

A sixth aspect of the present invention is the honeycomb structure according to any one of the first to fifth aspects, in which a void between the coating layer and a surface of the target cell has a maximum width of less than or equal to 15 μm.

A seventh aspect of the present invention is the honeycomb structure according to any one of the first to sixth aspects, in which the coating layer includes a thick portion where the thickness of the coating layer is locally at a maximum, and a thin portion where the thickness of the coating layer is locally at a minimum. A ratio of the thickness of the thick portion to the thickness of the thin portion is twice or less.

An eighth aspect of the present invention is a method of producing a honeycomb structure that includes a) preparing a base material that is a tubular member and provided with a plurality of cells extending from one end face to the other end face, b) preparing slurry that contains magnetic particles and a clay mineral, c) applying the slurry to a surface of a target cell that is at least one of the plurality of cells, and d) forming a coating layer on the surface of the target cell by drying and firing the slurry applied to the target cell.

A ninth aspect of the present invention is the method of producing a honeycomb structure according to the eighth aspect, in which the clay mineral contains at least one selected from a group consisting of montmorillonite, sepiolite, hectorite, halloysite, and attapulgite.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 is a sectional view showing a configuration of an induction heater.

FIG. 2 is a plan view showing a honeycomb structure.

FIG. 3 is a sectional view showing a target cell and its vicinity.

FIG. 4 is a sectional view showing a coating layer at a corner.

FIG. 5 is a sectional view showing the coating layer on a flat portion.

FIG. 6 is a sectional view showing the coating layer at a corner.

FIG. 7 is a sectional view showing the coating layer at a corner.

FIG. 8 is a flowchart of production of a honeycomb structure.

FIG. 9 is a diagram showing how slurry is applied to a target cell.

FIG. 10A shows an SEM image of a target cell in which the coating layer has a thickness of less than 20 μm.

FIG. 10B shows an SEM image of a target cell in which the coating layer has a thickness of greater than or equal to 20 μm.

FIG. 11A shows an SEM image of a target cell in which the ratio of the thickness of a thick portion to the thickness of a thin portion is more than twice.

FIG. 11B shows an SEM image of a target cell in which the ratio of the thickness of the thick portion to the thickness of the thin portion is twice or less.

FIG. 12 is a diagram showing an induction heating coil.

### DETAILED DESCRIPTION

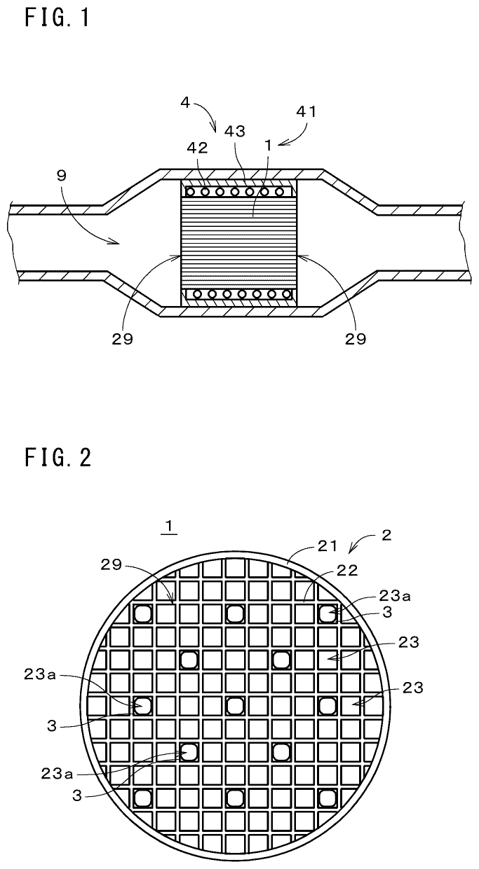

FIG. 1 is a sectional view showing a configuration of an induction heater 4. The induction heater 4 is placed in a flow path 9 of exhaust gas exhausted from an engine of a vehicle such as an automobile. The induction heater 4 includes an exhaust gas purifier 41, a coil 42, and a fixing member 43. The exhaust gas purifier 41 includes a honeycomb structure 1 serving as a catalyst carrier, and a catalyst carried by the honeycomb structure 1. The honeycomb structure 1 is a tubular member and provided with a plurality of cells 23 (see FIG. 2 described later) that extend along the flow path 9. The exhaust gas flows through the inside of the cells 23. The catalyst in the exhaust gas purifier 41 may, for example, be a precious metal catalyst or may be a catalyst not using precious metal. The details of the honeycomb structure 1 will be described later.

The coil 42 is a conductive wire formed in a spiral shape and surrounds the periphery of the honeycomb structure 1. The fixing member 43 fixes the exhaust gas purifier 41 and the coil 42 to the inside of the flow path 9. The coil 42 is connected to an alternating-current power supply (not shown), and the flow of the alternating current through the coil 42 generates a periodically changing magnetic field around the coil 42. As will be described later, the honeycomb structure 1 contains magnetic particles, and the temperature of the honeycomb structure 1 rises in response to changes in magnetic field. The rise in the temperature of the honeycomb structure 1 raises the temperature of the catalyst and facilitates catalytic reactions.

FIG. 2 is a simplified plan view of the honeycomb structure 1. As described previously, the honeycomb structure 1 is a tubular member that is long in one direction. FIG. 2 shows one end face of the honeycomb structure 1 in a longitudinal direction (which is the right-left direction in FIG. 1 and a direction perpendicular to the plane of the drawing in FIG. 2). In the following description, the honeycomb structure 1 does not yet carry the catalyst.

The honeycomb structure 1 includes a base material 2 and a coating layer 3. The base material 2 is a tubular member formed of a porous sintered compact and has two end faces 29 (see FIG. 1) in the longitudinal direction. The base material 2 has a tubular outer wall 21 and a partition wall 22. The tubular outer wall 21 is a tube-like portion extending in the longitudinal direction. For example, the tubular outer wall 21 may have an approximately circular sectional shape perpendicular to the longitudinal direction. This sectional shape may be any other shape such as a polygonal shape.

The partition wall 22 is a lattice portion that is provided inside the tubular outer wall 21 and partitions the inside into the plurality of cells 23. Each of the cells 23 forms a space extending in the longitudinal direction. Each cell 23 extends from one of the end faces 29 to the other end face 29. The previously-described catalyst is introduced into the cells 23. For example, each cell 23 may have an approximately square sectional shape perpendicular to the longitudinal direction. This sectional shape may be any other shape such as a polygonal shape or a circular shape. The cells 23 have the same sectional shape as a rule, but may include cells 23 having different sectional shapes. The base material 2 has a cell structure whose inside is partitioned into the cells 23 by the partition wall 22.

The tubular outer wall 21 and the partition wall 22 are porous portions. For example, the tubular outer wall 21 and the partition wall 22 may be formed of ceramic such as cordierite. The materials for the tubular outer wall 21 and the partition wall 22 may be ceramic other than cordierite, or may be materials other than ceramic. Typically, the materials have insulating properties.

The base material 2 including the tubular outer wall 21 and the partition wall 22 may have a porosity of, for example, higher than or equal to 20% and preferably higher than or equal to 30%. The porosity of the base material 2 may also be, for example, lower than or equal to 80% and preferably lower than or equal to 70%. The base material 2 may have an open porosity of, for example, higher than or equal to 40% and preferably higher than or equal to 55%. The open porosity of the base material 2 may also be, for example, lower than or equal to 65%. The porosity and open porosity of the base material 2 can be measured by the Archimedes method.

The base material 2 may have a mean pore diameter of, for example, greater than or equal to 5 μm and preferably greater than or equal to 8 μm. The mean pore diameter of the base material 2 may also be, for example, smaller than or equal to 30 μm and preferably smaller than or equal to 25 μm. The mean pore diameter can be measured by a mercury porosimeter. The base material 2 may have a surface open area ratio of, for example, higher than or equal to 20% and preferably higher than or equal to 25%. The surface open area ratio of the base material 2 may also be, for example, lower than or equal to 60% and preferably lower than or equal to 50%. The surface open area ratio refers to the ratio of the area of regions in which pores are open to the area of the surface of the base material 2 and can be obtained through image analysis of a scanning electron microscopic (SEM) image of the surface. The SEM image may be captured at, for example, 500× magnification.

The base material 2 may have a cell density (i.e., the number of cells 23 per unit area in a section perpendicular to the longitudinal direction) of, for example, higher than or equal to 10 cells/cm², preferably higher than or equal to 20 cells/cm², and more preferably higher than or equal to 30 cells/cm². The cell density may also be, for example, lower than or equal to 200 cells/cm² and preferably lower than or equal to 150 cells/cm². In the illustration in FIG. 2, the size of the cells 23 is greater than the actual size, and the number of cells 23 is smaller than the actual number. The features such as the size and number of the cell 23 may be modified in various ways.

The coating layer 3 is a porous sintered body and provided on some of the cells 23a (hereinafter, referred to as “target cells 23a”). The coating layer 3 extends around the entire perimeters of the target cells 23a and typically covers almost the entire surfaces (i.e., the inner surfaces) of the target cells 23a. Preferably, the target cells 23a provided with the coating layer 3 may be distributed evenly. In the example shown in FIG. 2, at least one cell 23 that is not provided with the coating layer 3 exists between each target cell 23a and another target cell 23a. This allows a rapid rise in the temperature of the honeycomb structure 1 and increases the ultimate temperature of the honeycomb structure 1, as compared with the case in which the coating layer 3 is formed on all of the cells 23. In actuality, it is confirmed that in a honeycomb structure including 300 cells, if the coating layer is formed on only 9, 21, 45, or 61 cells that are located at approximately regular intervals without being adjacent to one another, a more rapid rise in temperature becomes possible and the ultimate temperature becomes higher than in the case where the coating layer is formed on all of the cells. Depending on the design of the honeycomb structure 1, all of the cells 23 may be target cells 23a.

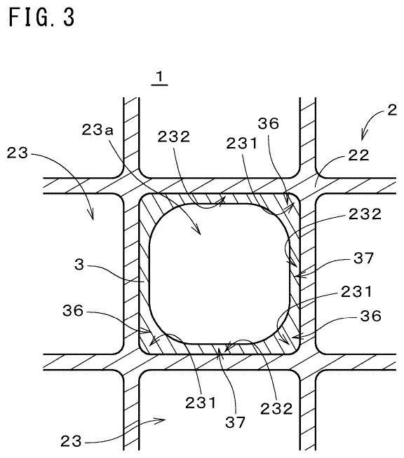

FIG. 3 is a sectional view showing one target cell 23a and its vicinity, and shows a section perpendicular to the longitudinal direction. The “section” as used in this specification refers to a section perpendicular to the longitudinal direction of the honeycomb structure 1, unless otherwise specified. In the example shown in FIG. 3, each cell 23 or 23a has an approximately square sectional shape perpendicular to the longitudinal direction. The inner surface of each cell 23 or 23a includes four corners 231 and four flat portions 232. Each two adjacent corners 231 of each cell 23 or 23a are connected by one flat portion 232. Each corner 231 is formed by an intersection of the lattice partition wall 22, and each flat portion 232 is formed by a portion (also called a rib) between intersections of the partition wall 22.

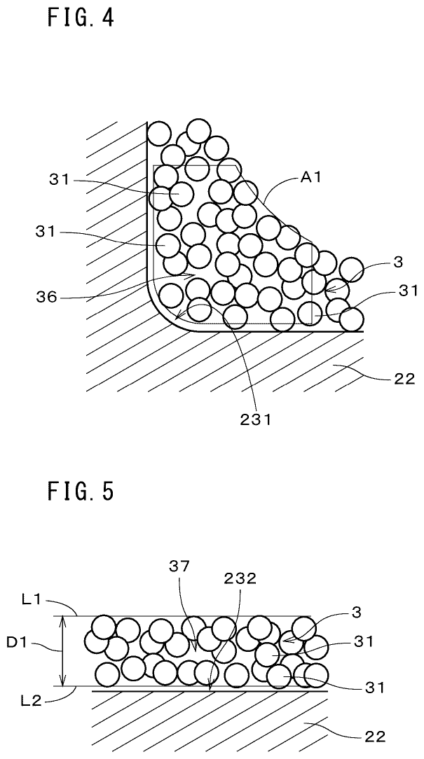

FIG. 4 is a sectional view showing the coating layer 3 at one corner 231, and FIG. 5 is a sectional view showing the coating layer 3 on one flat portion 232. The coating layer 3 is a layer formed by magnetic particles 31 that are bonded to one another by sintering. In FIGS. 4 and 5, the magnetic particles 31 are schematically illustrated as circles. The magnetic particles 31 may be any fine particulate matter, and fine chips of a magnetic material are also regarded as magnetic particles.

The magnetic particles 31 may, for example, be metal particles. Preferable magnetic particles 31 are formed of ferrite stainless steel and contains iron (Fe) and chromium (Cr) as main constituent elements. The main constituent elements as used herein refer to elements that each occupy 3 wt % or more of the constituent elements of the magnetic particles 31. The magnetic particles 31 may be formed of any other material that can cause induction heating. Examples of the magnetic particles 31 include martensitic stainless steel, austenitic stainless steel, invar, and super invar. The magnetic particles 31 may also be other than metal particles.

The coating layer 3 contains at least one element selected from among Si, Al, and Mg as an additional element(s). The additional element(s) refers to an element that is not included in the main constituent elements of the magnetic particles 31. The additional element(s) is an element that is not contained in the magnetic particles 31 as a rule, but there are cases in which the additional element(s) is unavoidably contained as impurities or the like in the magnetic particles 31. As will be described later, in the formation of the coating layer 3, a raw material that contains an additional element(s) is used together with the magnetic particles 31. Thus, in the coating layer 3, the ratio of the sum of the weight fraction(s) of the additional element(s) to the sum of the weight fraction(s) of the main constituent element(s) of the magnetic particles 31 (this ratio is hereinafter referred to as the “ratio of the additional element(s) to the magnetic particles”) is higher than or equal to 1.7 wt %. The weight fraction of each element is the ratio of the weight of the element to the weight of the coating layer 3.

For example, in the case where the magnetic particles 31 are ferrite stainless steel particles and montmorillonite is used as the raw material containing an additional element(s), the main constituent elements of the magnetic particles 31 are Fe and Cr, and the additional elements include all of Si, Al, and Mg. In this case, the ratio of the additional elements to the magnetic particles is the ratio of the sum of the weight fractions of Si, Al, and Mg to the sum of the weight fractions of Fe and Cr. For example, in the case where the coating layer 3 does not contain Mg, the additional elements are only Si and Al, and in the case where the coating layer 3 does not contain Al, the additional elements are only Si and Mg.

As will be described later, if the ratio of the additional elements to the magnetic particles in the coating layer 3 is higher than or equal to 1.7 wt %, the honeycomb structure 1 achieves improved thermal shock resistance. In the case of acquiring the ratio of the additional elements to the magnetic particles, a measurement using an energy dispersive X-ray spectroscopy analyzer (EDS) is conducted on a section of the coating layer 3 to obtain the weight fraction of each main constituent element of the magnetic particles 31 and the weight fraction of each additional element. Then, the sum of the weight fractions of the additional elements is divided by the sum of the weight fractions of the main constituent elements of the magnetic particles 31 to obtain the ratio of the additional elements to the magnetic particles.

Typically, a compound that contains an additional element(s) exists at the surfaces of the magnetic particles 31. The surfaces of the magnetic particles 31 include not only the surfaces of the magnetic particles 31 that form the outer edge of the coating layer 3 but also the interfaces of the magnetic particles 31 and pores formed inside the coating layer 3. For example, the compound may not contain the main constituent elements of the magnetic particles 31. Alternatively, the compound may contain any of the main constituent elements of the magnetic particles 31. Whether a compound containing an additional element(s) exists at the surfaces of the magnetic particles 31 can be checked by, for example, conducting element mapping using an EDS on a section of the coating layer 3. The additional element(s) may exist at the interfaces of the magnetic particles 31, or may be solid dissolved in the crystalline phase of the magnetic particles 31.

The coating layer 3 may have a relative density of, for example, higher than or equal to 75% and preferably higher than or equal to 80%. This ensures connectivity of the magnetic particles 31 and allows an increase in the ultimate temperature that the honeycomb structure 1 can reach by induction heating. In the case where the coating layer 3 has an excessively high relative density, the amount of thermal expansion of the coating layer 3 may increase and affect the thermal shock resistance of the honeycomb structure 1. The relative density of the coating layer 3 may also be, for example, lower than or equal to 95% and preferably lower than or equal to 90%. To acquire the relative density of the coating layer 3, an SEM image (at 500× magnification) that shows a section of the coating layer 3 at one corner 231 is acquired, and a calculation range that includes only the coating layer 3 (a range enclosed by the line with a reference sign A1 in FIG. 4) is set. Then, in the SEM image, the calculation range A1 is binarized using a threshold value that allows a distinction between a while region indicating the magnetic particles 31 and the other region, and the area ratio of the white region is acquired as the relative density of the coating layer 3.

In the formation of the coating layer 3, which will be described later, slurry is applied to the surfaces (inner surfaces) of the target cells 23a. As shown in FIG. 3, in the case where each target cell 23a has an approximately square sectional shape, the thickness of the coating layer 3 is locally at the minimum in the center between each two adjacent comers 231 (in the center of each flat portion 232) due to the influence of surface tension of the slurry, and a portion of the coating layer 3 that is located in the center becomes a thin portion 37. At each corner 231, the thickness of the coating layer 3 is locally at the maximum, and a portion of the coating layer 3 that is located at the corner 231 becomes a thick portion 36. In the following description, the “thickness of the coating layer 3” as simply referred to means the thickness of the thin portions 37 on the flat portions 232.

For example, the thickness of the coating layer 3 (i.e., the thickness of the thin portions 37) may be greater than or equal to 20 μm and preferably greater than or equal to 30 μm. This allows an increase in the ultimate temperature that the honeycomb structure 1 can reach by induction heating. In the case where the thickness of the coating layer 3 is excessively large, the cost for the formation of the coating layer 3 will increase. The thickness of the coating layer 3 may also be, for example, less than or equal to 100 μm and preferably less than or equal to 80 μm. To measure the thickness of the thin portions 37, an SEM image (at 500× magnification) that shows a section of the coating layer 3 in the center between two adjacent corners 231 (in the center of a flat portion 232) is acquired. Then, in the SEM image, parallel lines L1 and L2 that extend along both surfaces of the coating layer 3 are set (see FIG. 5), and a distance D1 between the parallel lines L1 and L2 is measured as the thickness of the thin portions 37. In the case where the surface of the coating layer 3 shown in the SEM image includes an irregular recessed or raised portion, the parallel lines L1 and L2 are set to extend along the surface excluding the recessed or raised portion.

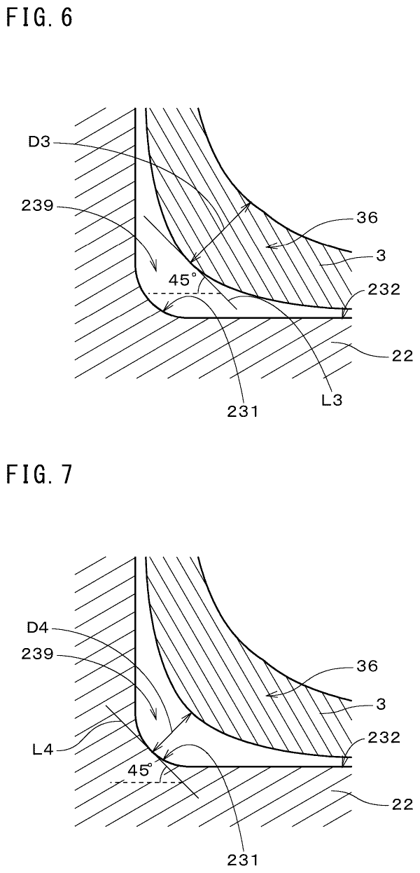

Preferably, the thickness of the thick portions 36 may not become excessively larger than the thickness of the thin portions 37. The ratio of the thickness of the thick portions 36 to the thickness of the thin portions 37 may preferably be twice or less and more preferably 1.8 times or less. In this way, in the honeycomb structure 1 that improves uniformity in the thickness of the coating layer 3, it is possible to suppress degradation in thermal shock resistance caused by nonuniformity in the thickness of the coating layer 3. To measure the thickness of the thick portions 36, an SEM image (at 500× magnification) that shows a section of the coating layer 3 at a corner 231 is acquired as schematically shown in FIG. 6. Then, in the SEM image, a tangent line L3 that has an inclination angle of 45° relative to a flat portion 232 and that is in contact with the outer periphery of a thick portion 36 is set, and a shortest distance D3 between the tangent line L3 and the inner periphery of the thick portion 36 is measured as the thickness of the thick portion 36.

In the case where the sectional shape of each target cell 23a is an approximately regular polygonal shape other than an approximately square shape, typically a portion of the coating layer 3 that faces each corner becomes a thick portion, and a portion of the coating layer 3 in the center between each two adjacent thick portions becomes a thin portion. Even if each target cell 23a has a circular sectional shape, the coating layer 3 may have thick portions where the thickness of the coating layer 3 is locally at the maximum (e.g., in each range obtained by dividing the circumference of the target cell 23a into four sections) and thin portions where the thickness of the coating layer 3 is locally at the minimum, depending on the technique for forming the coating layer 3. In any case, it is possible to improve the thermal shock resistance more reliably by setting the ratio of the thickness of the thick portions to the thickness of the thin portions to be twice or less.

Since the coating layer 3 is a sintered body as described previously, a void 239 (hereinafter, referred to as a “corner void 239”) may be formed between the coating layer 3 and the surface of each corner 231 of each target cell 23a by firing shrinkage. For example, the corner void 239 may have a width of less than or equal to 15 μm and preferably less than or equal to 12 μm. The evaluation of thermal shock resistance described later shows that stress concentration occurs at the boundaries between the non-contact portions (aforementioned corner voids 239) and the contact portions of the coating layer 3 and the cell surfaces. Thus, the honeycomb structure 1 including the corner voids 239 with small widths can more reliably achieved improved thermal shock resistance. The width of the corner voids 239 may be zero. There is a possibility that voids may also be formed even at portions other than the corners 231 between the coating layer 3 and the surfaces of the target cells 23a, but in the case where the target cells 23a have an approximately square sectional shape, the width of the corner voids 239 becomes a maximum width of the voids formed between the coating layer 3 and the surfaces of the target cells 23a.

To measure the width of the corner voids 239, an SEM image (at 500× magnification) that shows a section of the coating layer 3 at a corner 231 is acquired as schematically illustrated in FIG. 7. Then, in the SEM image, a tangent line L4 that has an inclination angle of 45° relative to a flat portion 232 and that is in contact with the corner 231 (the inner surface of the target cell 23a) is set, and a shortest distance D4 between the tangent line L4 and the outer periphery of the thick portion 36 is measured as the width of the corner void 239. Even if the target cells 23a have a different sectional shape (e.g., polygonal or circular shape) other than an approximately square sectional shape, the honeycomb structure 1 can more reliably achieve improved thermal shock resistance if the maximum width of the voids between the coating layer 3 and the surfaces of the target cells 23a is less than or equal to 15 μm.

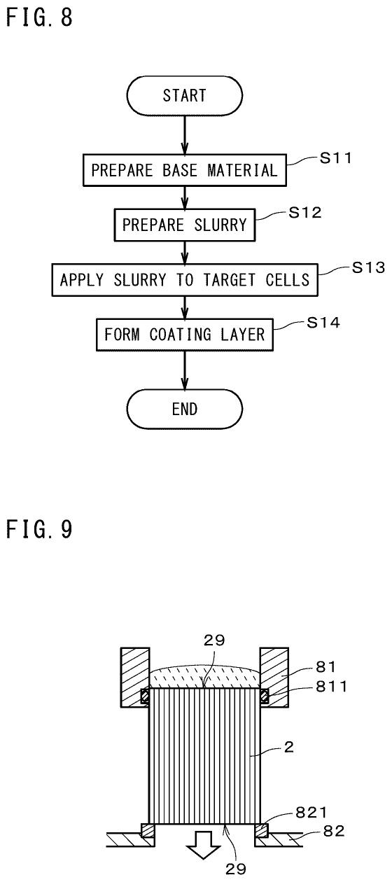

Next, one example of producing the honeycomb structure 1 will be described. FIG. 8 is a flowchart of production of the honeycomb structure 1. In the production of the honeycomb structure 1, firstly, the base material 2 is prepared (step S11). The base material 2 is provided with the plurality of cells 23 extending from one end face 29 to the other end face 29 (see FIGS. 1 and 2). Any of various known methods may be used as the method of producing the base material 2. Typically, the base material 2 is produced by extrusion molding, drying, and firing of a green body.

Then, slurry for forming a coating layer is prepared (step S12). In the preparation of the slurry, powder of a magnetic material serving as magnetic particles, powder of a clay mineral, and a dispersion medium (in the present example, water) are weighed and mixed together in a container. The magnetic particles may be powder of any previously-described material. The clay mineral is a layered mineral and preferably contains at least one selected from the group consisting of montmorillonite, sepiolite, hectorite, halloysite, and attapulgite. The slurry containing the clay mineral has higher shear strength (slip strength) and viscosity than slurry that does not contain any clay mineral.

The clay mineral loading on the magnetic particles may preferably be higher than or equal to 4 vol %. This reduces the width of the previously-described corner voids 239 in the coating layer 3 to be formed, and reduces the ratio of the thickness of the thick portions 36 to the thickness of the thin portions 37. The clay mineral loading on the magnetic particles may also preferably be lower than or equal to 9 vol %. This prevents an excessive increase in the viscosity of the slurry. The previously-described additional element(s) contained in the coating layer 3 is an element(s) derived from the aforementioned clay mineral. Among the raw materials contained in the slurry in the present embodiment, those other than the clay mineral hardly contain the additional element(s).

After the slurry is prepared, the slurry is applied to the surfaces of the target cells 23a of the base material 2 (step S13). During the application of the slurry, the base material 2 stands upright so that the cells 23 faces in the up-down direction, and an upper jig 81 and a lower jig 82 are attached to upper and lower portions of the base material 2, respectively, as shown in FIG. 9. To be specific, the upper jig 81 is an approximately cylindrical member that has an inside diameter slightly larger than the diameter of the base material 2. The upper jig 81 has a ring-shaped groove in the lower portion of the inner surface, and a ring-shaped rubber tube 811 is placed in this groove. The upper jig 81 is fitted in the upper portion of the base material 2 to come in contact with the outer surface of the base material 2 via the rubber tube 811. The lower jig 82 is an approximately circular ring-shaped member that has an inside diameter slightly smaller than the diameter of the base material 2. The lower jig 82 has a silicon O-ring 821 provided in a portion of the upper surface in the vicinity of the inner periphery. The base material 2 is placed on the lower jig 82 so that the outer peripheral portion of the lower end face 29 of the base material 2 comes in contact with the lower jig 82 via the silicon O-ring 821.

When the upper jig 81 and the lower jig 82 are attached to the base material 2, a predetermined amount of slurry is poured into the inside of the upper jig 81, so that the slurry is charged on the upper end face 29 of the base material 2. At this time, the base material 2 is provided with a covering material (not shown) that covers the upper end face 29, and holes are formed in portions of the covering material that face the target cells 23a. This allows the slurry to flow into only the target cells 23a. Then, the space on the side of the lower end face 29 of the base material 2 is pumped by vacuum suction using a pump. Accordingly, the slurry flows from the openings of the target cells 23a on the side of the upper end faces 29 into the target cell 23a and is applied to the surfaces (inner surfaces) of the target cells 23a. The slurry that has passed through the target cells 23a flows out from the openings on the side of the lower end face 29 to the outside. When the application of the slurry to the target cells 23a is completed, the upper jig 81 and the lower jig 82 are removed from the base material 2.

Then, the slurry applied to the target cells 23a is dried. As described previously, since the slurry containing a clay mineral has high shear strength, it is possible to suppress aggregation of the slurry at the corners 231 due to surface tension. That is, uniformity in the thickness of the slurry after drying (uniformity in the circumferential direction of the target cells 23a) is improved. The application and drying of the slurry may be repeated multiple times. Thereafter, firing (heat treatment) is conducted in a vacuum atmosphere. The firing temperature may be in the range of, for example, 1050° C. to 1250° C. The firing time may be in the range of, for example, 5 minutes to 70 minutes. Accordingly, the coating layer 3 is formed on the surfaces of the target cells 23a, and the production of the honeycomb structure 1 is completed (step S14). The firing temperature and the firing time described above are merely examples and may be changed as appropriate. Note that the clay mineral contained in the slurry is considered to be decomposed by firing and does not almost exist as the as-is clay mineral in the honeycomb structure 1.

Next, Examples 1 to 9 of the honeycomb structure according to the present invention and Comparative Examples 1 and 2 will be described with reference to Table 1.

TABLE 1

| | Mont- | Water | | | | Thick- | Relative | Width | Thickness | | |
|---|---|---|---|---|---|---|---|---|---|---|---|
| | moril- | Ratio | | | | ness of | Density of | of | Ratio of | Ultimate | Thermal |
| | lonite | [parts | | | (Si + Al + Mg)/ | Coating | Coating | Corner | Thick | Temper- | Shock |
| | Loading | by | Coating | | (Fe + Cr) | Layer | Layer | Voids | Portions to | ature | Resis- |
| | [vol %] | weight] | Count | Firing Schedule | [wt %] | [μm] | [%] | [μm] | Thin Portions | [° C.] | tance |
| Example 1 | 7 | 30 | 1 | 1200° C.*30 min | 2.3 | 30 | 80 | 10 | Twice | 450 | ◯ |
| Example 2 | 7 | 28 | 2 | 1200° C.*30 min | 2.1 | 50 | 80 | 10 | 1.5 times | 520 | ◯ |
| Example 3 | 7 | 28 | 3 | 1200° C.*30 min | 2.3 | 70 | 80 | 10 | 1.5 times | 580 | ◯ |
| Example 4 | 7 | 28 | 2 | 1100° C.*30 min | 2.1 | 50 | 75 | 10 | 1.5 times | 500 | ◯ |
| Example 5 | 7 | 30 | 2 | 1200° C.*60 min | 2 | 50 | 95 | 15 | 1.7 times | 620 | ◯ |
| Example 6 | 7 | 42 | 1 | 1200° C.*30 min | 2.2 | 10 | 80 | 5 | Thrice | 210 | ◯ |
| Example 7 | 7 | 28 | 2 | 1100° C.*30 min | 2.3 | 50 | 70 | 5 | 1.5 times | 390 | ◯ |
| Example 8 | 4 | 28 | 2 | 1200° C.*30 min | 1.7 | 30 | 95 | 20 | Thrice | 490 | ◯ |
| Example 9 | 9 | 35 | 1 | 1200° C.*30 min | 2.5 | 70 | 80 | 10 | 1.5 times | 540 | ◯ |
| Comparative | No | 28 | 2 | 1200° C.*30 min | 0.9 | 50 | 90 | 50 | Thrice | 610 | X |
| Example 1 | loading | | | | | | | | | | |
| Comparative | No | 35 | 2 | 1200° C.*30 min | 1.1 | 30 | 95 | 50 | Thrice | 510 | X |
| Example 2 | loading | | | | | | | | | | |

### Examples 1 to 9

Stainless steel (SUS430) powder serving as magnetic particles, montmorillonite serving as a clay mineral, and ion-exchanged water were weighed. In FIG. 1, for each of Examples 1 to 9, the montmorillonite loading [vol %] on the stainless steel powder is shown in the “Montmorillonite Loading” field, and the amount of water [parts by weight] relative to the stainless steel powder and montmorillonite is shown in the “Water Ratio” field. These materials were put together with ZrO₂ beads (φ5 mm) in a container and mixed together by a rotary and revolutionary mixer so as to prepare slurry. Then, a base material was prepared, whose inside was partitioned into a plurality of cells by a partition wall. As described with reference to FIG. 9, an upper jig and a lower jig were attached to upper and lower portions of the base material, respectively, so as to apply the slurry to the surface of each cell. Thereafter, the slurry was dried. In Table 1, the number of times the application and drying of the slurry were repeated is shown in the “Coating Count” field. Then, firing was conducted in a vacuum atmosphere. In Table 1, the firing temperature and the firing time are shown in the “Firing Schedule” field. The rate of a temperature rise was set to 500° C./hr. Through the processing described above, the honeycomb structures according to Examples 1 to 9 were obtained.

### Comparative Examples 1 and 2

Stainless steel (SUS430) powder, a water-soluble binder, a thickener, and ion-exchanged water were weighed. In Comparative Examples 1 and 2, montmorillonite was not added to slurry. These materials were put together with ZrO₂ beads (φ5 mm) in a container and mixed together by a rotary and revolutionary mixer so as to prepare slurry. The application and drying of the slurry were conducted in the same manner as in Examples 1 to 9. Thereafter, the base material was held at 180° C. for four hours in an ambient atmosphere and then held at 450° C. for six hours for degreasing. After the degreasing, firing was conducted in the same manner as in Examples 1 to 9 so as to obtain the honeycomb structures according to Comparative Examples 1 and 2.

### Measurements of Coating Layer

Measurements were conducted on the honeycomb structures according to Examples 1 to 9 and Comparative Examples 1 and 2 so as to obtain the ratio of the additional elements to the magnetic particles, the thickness of the coating layer, the relative density of the coating layer, the width of the corner voids, and the ratio of the thickness of the thick portions to the thickness of the thin portions. To obtain the ratio of the additional elements to the magnetic particles, measurements using an EDS and a DX200s Digital Pulse Processor manufactured by RaySpec Ltd. were conducted on a section of the coating layer that had undergone mirror grinding so as to obtain the weight fraction of each main constituent element of the magnetic particles and the weight fraction of each additional element. Then, the sum of the weight fractions of the additional elements was divided by the sum of the weight fractions of the main constituent elements of the magnetic particles so as to obtain the ratio of the additional elements to the magnetic particles. In the present examples, since the main constituent elements of the magnetic particles were Fe and Cr and the additional elements were Si, Al, and Mg, the ratio of the additional elements to the magnetic particles is described as “(Si+Al+Mg)/(Fe+Cr)” in Table 1.

In Comparative Examples 1 and 2, the slurry did not contain montmorillonite, but unavoidably contained at least one element selected from among Si, Al, and Mg as impurities or the like. Thus, (Si+Al+Mg)/(Fe+Cr) was higher than 0 wt % and lower than 1.7 wt %. In Examples 1 to 9 that used the slurry containing montmorillonite, on the other hand, (Si+Al+Mg)/(Fe+Cr) was higher than or equal to 1.7 wt %.

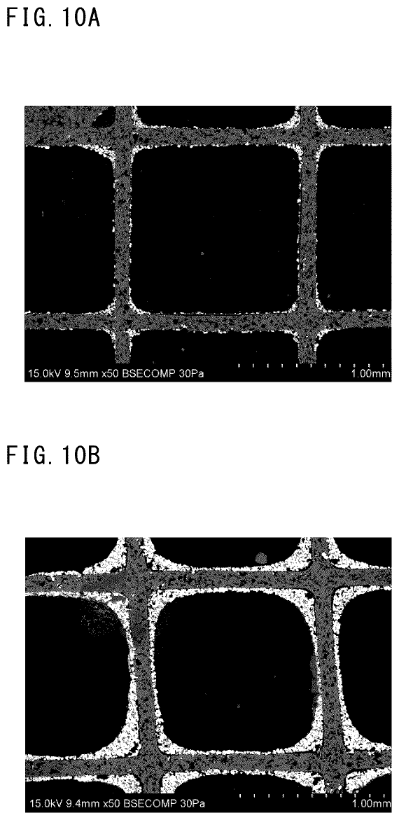

To measure the thickness of the coating layer, the relative density of the coating layer, the width of the corner voids, and the ratio of the thickness of the thick portions to the thickness of the thin portions, an SEM image (at 500× magnification) was acquired using an SEM (JSM-IT500 manufactured by JEOL Ltd.) and image analysis was conducted using image analysis software “Image-pro Premier 9.3” manufactured by Media Cybernetics. As described with reference to FIG. 5, in the SEM image showing a thin portion, the distance between parallel lines that extend along both surfaces of the thin portion was measured as the thickness of the coating layer. FIG. 10A shows an SEM image of a target cell in which the coating layer has a thickness of less than 20 μm, and FIG. 10B shows an SEM image of a target cell in which the coating layer has a thickness of greater than or equal to 20 μm. As described with reference to FIG. 4, in the SEM image showing a thick portion, a calculation range including only the coating layer was set and binarized using a threshold value that allowed a distinction between the magnetic particles and the other region, and the area ratio of a region showing the magnetic particles was acquired as the relative density of the coating layer.

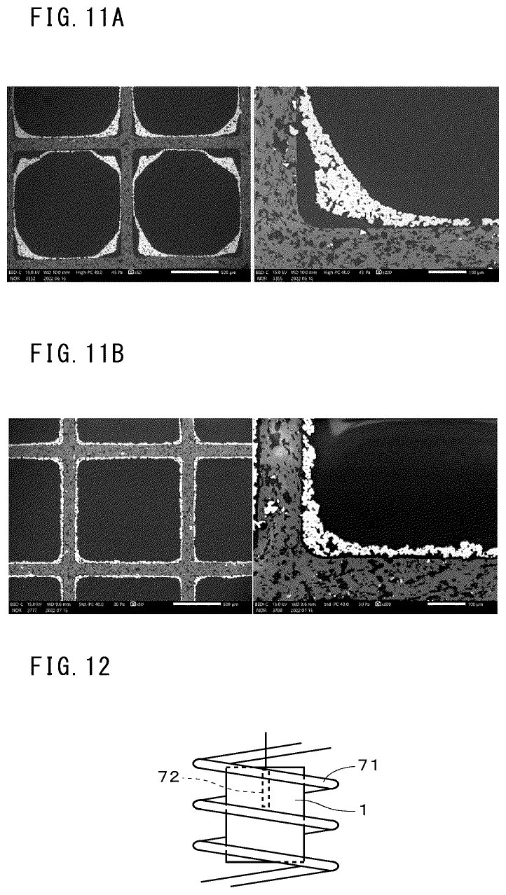

As described with reference to FIG. 7, in the SEM image showing a thick portion, a tangent line that had an inclination angle of 45° relative to a flat portion and that was in contact with a corner was set, and a shortest distance between the tangent line and the outer periphery of the thick portion was measured as the width of the corner void. As described with reference to FIG. 6, in the SEM image showing a thick portion, a tangent line that had an inclination angle of 45° relative to a flat portion and that was in contact with the outer periphery of the thick portion was set, and a shortest distance between the tangent line and the inner periphery of the thick portion was measured as the thickness of the thick portion. Then, the thickness of the thick portion was divided by the thickness of the previously-described coating layer (the thickness of the thin portion) so as to obtain the ratio of the thickness of the thick portions to the thickness of the thin portions. FIG. 11A shows an SEM image of a target cell in which the width of the corner voids is greater than 15 μm and the ratio of the thickness of the thick portions to the thickness of the thin portions is more than twice, and FIG. 11B shows an SEM image of a target cell in which the width of the corner voids is less than or equal to 15 μm and the ratio of the thickness of the thick portions to the thickness of the thin portions is twice or less.

### Evaluation of Induction Heating Characteristics

As shown in FIG. 12, the honeycomb structure 1 was placed inside an induction heating coil 71. The induction heating coil 71 was driven for 180 seconds under conditions of a frequency of 100 kHz and electric power of 0.5 kW so as to measure the ultimate temperature by a thermocouple 72 provided inside the honeycomb structure 1. As shown in Table 1, in Examples 1 to 5, 7 to 9 and Comparative Examples 1 and 2, all the honeycomb structures had ultimate temperatures of higher than or equal to 390° C. On the other hand, in Example 6 in which the thickness of the coating layer is less than 20 μm, the honeycomb structure had an ultimate temperature of 210° C.

### Evaluation of Thermal Shock Resistance

Evaluation using a bottom loading furnace maintained at 700° C. was conducted by vertically moving the furnace bottom on which the honeycomb structure was placed. Specifically, the furnace bottom was positioned at a lifting end and held for 10 minutes while the honeycomb structure was placed within the furnace. Thereafter, the furnace bottom was located at a lowering end so as to place the honeycomb structure outside the furnace (in an ambient atmosphere), and wind was blown to the honeycomb structure for five minutes by using a blower. This cooling and heating cycle was conducted 100 times, and thereafter the outer appearance of the honeycomb structure was observed. In Table 1, the cross represents an evaluation result for the case where cracks appeared in the honeycomb structure, and the open circle represents an evaluation result for the case where no cracks appeared. The results of evaluating the thermal shock resistance of the honeycomb structures according to Examples 1 to 9 are shown by open circles, whereas the results of evaluating the thermal shock resistance of the honeycomb structures according to Comparative Examples 1 and 2 are shown by crosses. It can be said that the honeycomb structures whose results of evaluating the thermal shock resistance are shown by open circles have repeated durability against thermal shock.

### Consideration of Coating Layer

In the honeycomb structures according to Comparative Examples 1 and 2 in which the slurry did not contain any clay mineral, the aggregation of the slurry at the corners was likely to be caused by surface tension immediately after the application of the slurry, and the slurry became excessively thick at the corners and excessively thin on the flat portions. In the firing of the slurry, large voids were formed at the corners between the coating layer and the surfaces of the target cells by firing shrinkage. As a result, it is considered in the evaluation of the thermal shock resistance that stress concentration occurs at the boundaries between the non-contact portions (aforementioned voids) and the contact portions of the coating layer and the cell surfaces, and cracks are likely to appear in the base material.

In contrast, according to Examples 1 to 9, as a result of adding montmorillonite serving as a clay mineral to the slurry, the slurry became a Bingham fluid and shearing stress was applied in a static state. That is, the slurry did not flow until the shearing stress exceeded a yield value, and this prevented the aggregation of the slurry from occurring at the corners due to surface tension immediately after the application of the slurry. It is also found that the addition of montmorillonite to the slurry increases the relative density of the magnetic particles after drying and before firing, and this reduces the amount of firing shrinkage. Besides, it is also confirmed that montmorillonite is decomposed and generates gas during firing. Due to the generation of the gas, closed pores are likely to be formed in the coating layer, and this prevents excessive densification of the magnetic particles. In this regard as well, the amount of firing shrinkage is reduced. As a result, it is considered that, as compared to Comparative Examples 1 and 2, the adhesion of the coating layer at the corners improves and reduces the size of the voids between the corners and the coating layers, thereby reducing the occurrence of cracks due to the stress concentration according to the evaluation of thermal shock resistance.

In the honeycomb structure according to Example 6, since the thickness of the coating layer was small (less than 20 μm), the ultimate temperature according to the evaluation of induction heating characteristics became considerably low. Therefore, it can be said that the coating layer may preferably have a thickness of greater than or equal to 20 μm in order to increase the ultimate temperature. In the honeycomb structure according to Example 7, the coating layer had a thickness of 50 μm, but the ultimate temperature was less than 400° C. and relatively low. This considered to be caused by the fact that in Example 7, since the relative density of the coating layer was relatively low (lower than 75%), the magnetic particles had low connectivity and made eddy current hard to flow. In other words, in order to raise the ultimate temperature, it is preferable to make the coating layer have a relative density of higher than or equal to 75% and to increase the filling factor of the magnetic particles.

As described above, the honeycomb structure 1 includes the base material 2 that is a tubular member and provided with the plurality of cells 23 extending from one end face 29 to the other end face 29, and the coating layer 3 that is provided on the surfaces of the target cells 23a that are at least some of the cells 23, the coating layer 3 being formed by the magnetic particles 31 bonded to one another. The coating layer 3 contains at least one element selected from among Si, Al, and Mg as an additional element(s). In the coating layer 3, the ratio of the sum of the weight fraction(s) of the additional element(s) to the sum of the weight fraction(s) of the main constituent element(s) of the magnetic particles 31 is higher than or equal to 1.7 wt %. Accordingly, it is possible to provide the honeycomb structure 1 having high thermal shock resistance (including repeated durability against thermal shock).

Preferably, the voids between the coating layer 3 and the surfaces of the target cells 23a have a maximum width of less than or equal to 15 μm and/or the ratio of the thickness of the thick portions 36 to the thickness of the thin portions 37 in the target cells 23a is twice or less. This more reliably improves the thermal shock resistance of the honeycomb structure 1.

Preferably, the coating layer 3 may have a relative density of 75% to 95% and/or the coating layer 3 may have a thickness of 20 μm to 100 μm. This increases the ultimate temperature that the honeycomb structure 1 can reach by induction heating.

Preferably, the main constituent elements of the magnetic particles 31 may include Fe and Cr. Such magnetic particles 31 preserve an excellent balance between electric resistivity and magnetic permeability and improves heating efficiency. The magnetic particles 31 may further contain Cr in order to obtain the coating layer 3 having excellent corrosion resistance.

Preferably, in the coating layer 3, a compound that contains the additional element(s) exists at the surfaces of the magnetic particles 31. The presence of the compound inhibits sintering of the magnetic particles 31 to some extent and allows control of the structure of the coating layer 3 that includes the magnetic particles 31 (e.g., connectivity of the magnetic particles 31 or the outside shape and relative density of the coating layer 3).

The method of producing the honeycomb structure 1 includes the step of preparing the base material 2 provided with the plurality of cells 23 (step S11), the step of preparing slurry that contains magnetic particles and a clay mineral (step S12), the step of applying the slurry to the surfaces of the target cells 23a that are at least some of the cells 23 (step S13), and the step of forming the coating layer 3 on the surfaces of the target cells 23a by drying and firing the slurry applied to the target cells 23a (step S14). Accordingly, it is possible to provide the honeycomb structure 1 having high thermal shock resistance.

Preferably, the clay mineral described above may contain at least one selected from the group consisting of montmorillonite, sepiolite, hectorite, halloysite, and attapulgite. This more reliably improves the thermal shock resistance of the honeycomb structure 1.

The honeycomb structure 1 and the method of producing the honeycomb structure 1 described above may be modified in various ways.

As long as the honeycomb structure 1 is capable of achieving high thermal shock resistance, the coating layer 3 may have a relative density that is outside the range of 75% to 95% or may have a thickness that is outside the range of 20 μm to 100 μm. The voids between the coating layer 3 and the surfaces of the target cells 23a may have a maximum width of greater than 15 μm, and the thickness of the thick portions 36 may be greater than twice of the thickness of the thin portions 37.

The honeycomb structure 1 may be produced by a method other than the production method shown in FIG. 8. The honeycomb structure 1 may be used in applications other than being used as a catalyst carrier.

The configurations of the above-described preferred embodiment and variations may be appropriately combined as long as there are no mutual inconsistencies.

While the invention has been shown and described in detail, the foregoing description is in all aspects illustrative and not restrictive. It is therefore understood that numerous modifications and variations can be devised without departing from the scope of the invention.

### REFERENCE SIGNS LIST

1 honeycomb structure
2 base material
3 coating layer
23 cell
23a target cell
29 end face of (the base material)
31 magnetic particles
36 thick portion
37 thin portion
239 corner void
S11 to S14 step

1. A honeycomb structure comprising:
a base material that is a tubular member and provided with a plurality of cells extending from one end face to the other end face; and
a coating layer that is provided on a surface of a target cell that is at least one of said plurality of cells, said coating layer being formed by magnetic particles bonded to one another,
wherein said coating layer contains at least one element selected from among Si, Al, and Mg as an additional element(s), and
in said coating layer, a ratio of a sum of a weight fraction(s) of said additional element(s) to a sum of a weight fraction(s) of a main constituent element(s) of said magnetic particles is higher than or equal to 1.7 wt %.

2. The honeycomb structure according to claim 1, wherein
said main constituent element(s) of said magnetic particles includes Fe and Cr.

3. The honeycomb structure according to claim 1, wherein
said coating layer includes a compound that contains said additional element(s) and that exists at surfaces of said magnetic particles.

4. The honeycomb structure according to claim 1, wherein
said coating layer has a relative density of 75% to 95%.

5. The honeycomb structure according to claim 1, wherein
said coating layer has a thickness of 20 μm to 100 μm.

6. The honeycomb structure according to claim 1, wherein
a void between said coating layer and a surface of said target cell has a maximum width of less than or equal to 15 μm.

7. The honeycomb structure according to claim 1, wherein
said coating layer includes:
a thick portion where the thickness of said coating layer is locally at a maximum; and
a thin portion where the thickness of said coating layer is locally at a minimum, and
a ratio of the thickness of said thick portion to the thickness of said thin portion is twice or less.

8. A method of producing a honeycomb structure, comprising:
a) preparing a base material that is a tubular member and provided with a plurality of cells extending from one end face to the other end face;
b) preparing slurry that contains magnetic particles and a clay mineral;
c) applying said slurry to a surface of a target cell that is at least one of said plurality of cells; and
d) forming a coating layer on said surface of said target cell by drying and firing said slurry applied to said target cell.

9. The method of producing a honeycomb structure according to claim 8, wherein
said clay mineral contains at least one selected from a group consisting of montmorillonite, sepiolite, hectorite, halloysite, and attapulgite.
